(19) United States
(12) Patent Application Publication
(10) Pub. No.: US 2010/0236171 A1
(43) Pub. Date: Sep. 23, 2010

(54) PREINSTALLED GLUE SYSTEM FOR FLOOR

(76) Inventor: David C. Liu, Marietta, GA (US)

Correspondence Address: Wang Law Firm, Inc., 4989 Peachtree Parkway,, Suite 200, Norcross, GA, 30092, US

(21) Appl. No.: 12/406,165

(22) Filed: Mar. 18, 2009

(51) Int. Cl. E04C 2/20; E04B 2/08; E04F 15/00; C09J 1/00

(52) U.S. Cl. 52/309.3; 52/588.1; 52/746.1

(57) ABSTRACT

Glue based hardwood floor boards are provided by this invention. The floor board includes a protruding tongue on one end and a receding groove on the other end. A string of glue capsules is placed inside the receding groove. When the protruding tongue of an adjacent floor board is forced inside the receding groove of the first floor board, the glue capsules are broken and the glue leaks into the receding groove, thus bonding two floor boards.

### FIELD OF THE INVENTION

The invention relates to wood flooring, and more particularly, to glue based wood flooring system.

### BACKGROUND OF THE INVENTION

Mechanical lock is widely used for hardwood and laminate flooring. The mechanical locking may be achieved through an external locking device or through a locking profile built into the floor board. The mechanical lock is often unable to maintain its lock as wooden boards deform because of changing the moisture level inside the wooden boards. This often shortens the lifetime of the floor. The mechanical lock cannot be relocked easily after water infiltrates inside the locks.

Mechanical lock could not achieve water sealing for a hardwood floor. The excess water on floor often leaks into/through the floor and remain under the floor boards. The water is likely to spread under the floor causing the boards to swell, thus damaging the floor. The water may also create mold and bacteria under the floor.

Mechanical lock sometime creates squeak sound because wood deformation, and this could not be easily eliminated because the squeak sound is caused by friction between the deformed floor boards.

Therefore, there is a need for a locking mechanism that is easy to install and strong enough to withstand deformation that often occurs on wood boards, and it is to this locking mechanism this invention is primarily directed.

### SUMMARY OF THE INVENTION

In one embodiment of the present invention, there is provided a floor board. The floor board has a length, a protruding tongue, a receding groove, and an adhesive placed inside the receding groove. The protruding tongue and the receding groove are located on the opposite ends of the floor board and extend along the length. The adhesive may be encapsulated into a string of glue capsules. The adhesive may also be sealed by two lateral seals and a protective film.

In another embodiment of the invention, there is provided another floor board that has an upwardly receding valley, an upwardly protruding tongue adjacent to the upwardly receding valley, and an adhesive placed inside the upwardly receding valley. The adhesive may be encapsulated into a string of glue capsules.

In another embodiment of the invention, there is provided a floor system. The floor system comprises a first floor board having a first end, a second floor board having a second end, and a connector having a first portion, a second portion, a first chamber located in the first portion, and a second chamber located in the second portion. The first end has a first receding groove and the first receding groove has a first aperture; the second end has a second receding groove and the second receding groove has a second aperture. The connector has a thickness, and the first chamber and the second chamber are filled with glue, the thickness of the connector is larger than the first aperture and the second aperture. After the first portion of the connector being inserted into the first receding groove and the second portion of the connector being inserted into the second receding groove, the glue from the first chamber leaks into the first receding groove and the glue from the second chamber leaks into the second receding groove.

In yet another embodiment of the invention there is provided a method for installing floor boards by placing a first floor board with a receding groove with adhesive on the surface, placing a second floor board with a protruding tongue adjacent to the first floor board, pressing the protruding tongue of the second floor board against the receding groove of the first floor board, inserting the protruding tongue of the second floor board into the receding groove of the first floor board, distributing the adhesive inside the receding groove, and attaching the protruding tongue to the receding groove.

In yet another embodiment of the invention there is provided an adhesive capsule for use inside a receding groove with a first width. The glue capsule has a first reservoir made from a thin film for storing adhesive and a resilient layer covering the first reservoir. The first reservoir has a base with a second width and the second width is wider than the first width.

### BRIEF DESCRIPTION OF THE DRAWINGS

Features and advantages of embodiments of the invention will become apparent as the following Detailed Description proceeds, and upon reference to the Drawings, where like numerals depict like elements, and in which:

FIG. 1 is a perspective view of two floor boards according to one embodiment of the invention;

FIG. 2 is a cross section view of two floor boards before being engaged to each other;

FIG. 3 is a cross section view of two floor boards after being engaged to each other;

FIGS. 4-7 depict a cross section view of two floor boards according to different embodiment of the invention;

FIG. 8 depicts a string of glue capsules;

FIG. 9 depicts a strip of glue capsules;

FIG. 10 depicts cross section AA view of a glue capsule;

FIG. 11 depicts an alternative embodiment for placing glue in a floor board;

FIG. 12 depicts two floor boards and a connector with encapsulated glue;

FIG. 13 depicts two floor boards and a connector with encapsulated glue in an engaged position;

FIG. 14 depicts two floor boards and a connector with encapsulated glue according to another embodiment of the invention;

FIG. 15 depicts two floor boards, one of them with a built-in glue compartment;

FIG. 16 depicts two floor boards of FIG. 15 in an engaged position;

FIG. 17 depicts an alternative embodiment of the present invention;

FIG. 18 depicts another alternative embodiment of the present invention;

FIG. 19 depicts another alternative embodiment of the present invention with two glue components; and

FIG. 20 depicts yet another alternative embodiment of the present invention for a two-glue capsule.

### DETAILED DESCRIPTION OF THE INVENTION

This application discloses different ways to used pre-installed glue to join floor boards. The glue may be capsulated before being installed on the floor boards and then during the installation, the glue breaks out from the capsules to join the floor boards. This installation mechanism allows the glue to start the curing process during the installation of each floor board and enables a precise amount of the glue to be employed at each location. The amount of glue used can be accurately determined and applied. The installer will not come into direct contact with the glue. The seal provided by the glue to the joint of two floor boards also prevents water damage caused by water penetration, reduces the noise at the joint, excludes the dirt from depositing at the joint, and restrains floor board deformations by binding the floor boards as one single unit. This invention will significantly extend the life time of the floor boards and ease the maintenance of the floor boards.

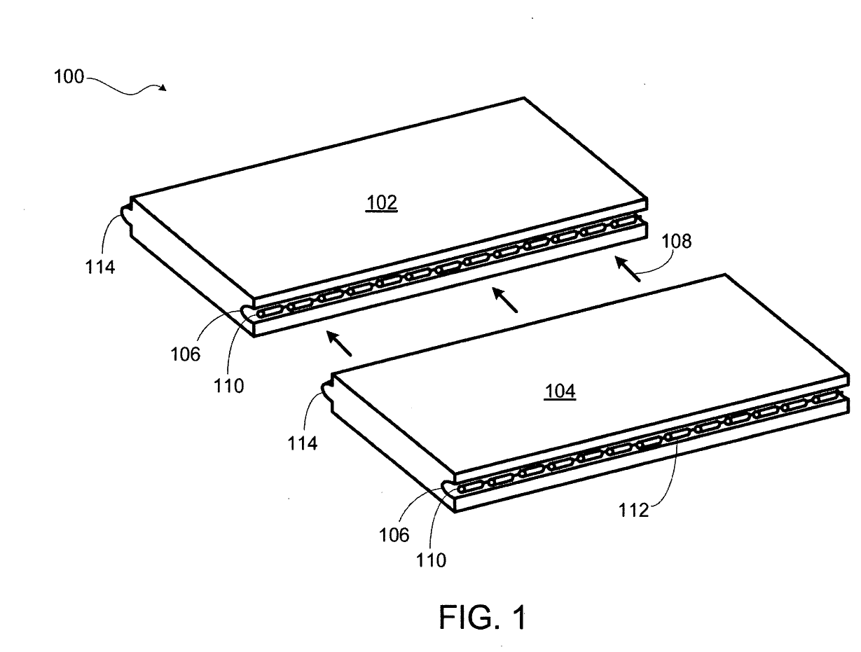

FIG. 1 is a perspective view 100 of two floor boards 102, 104 according to the invention. Each floor board has a profile that includes a protruding tongue 114 and a receding groove 106 where a string 110 of glue capsules 112 is placed. Both the protruding tongue 114 and receding groove 106 extend along the length of the floor boards 102, 104. When one floor board 104 is engaged to the other floor board 102 in the direction 108, the protruding tongue 114 of floor board 104 will press against the glue capsules 112 in the receding groove 106 and break these glue capsules 112. As the glue capsules 112 are broken, the glue spills out from the glue capsules 112 and fills up the space between the protruding tongue 114 and receding groove 106. The remnant of the glue capsules 112 stays between the protruding tongue 114 and receding groove 106 and surrounded by the glue. After the glue cured, two floor boards 102, 104 are firmly bonded together.

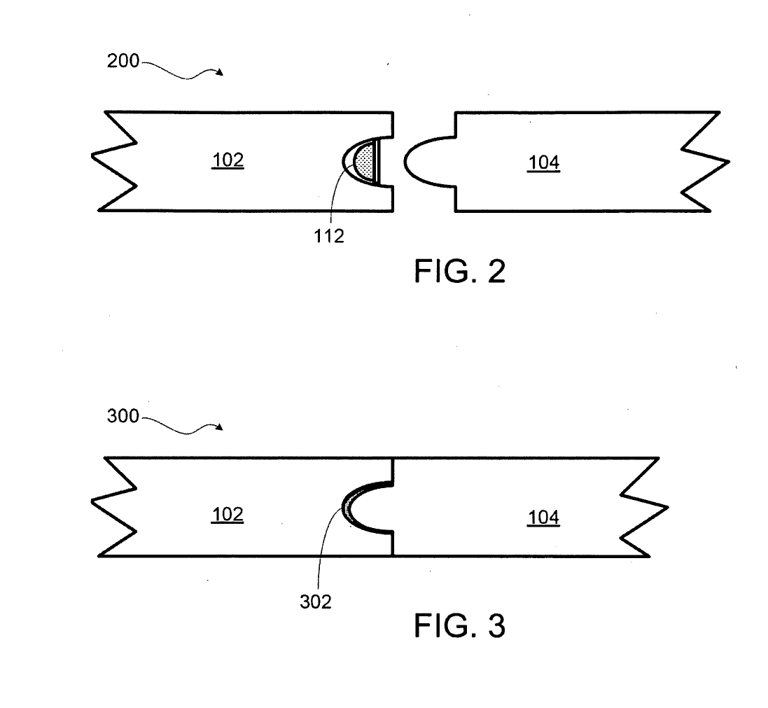

FIG. 2 is a cross section view 200 of two floor boards 102, 104 before engaging to each other. The glue capsule 112 is placed inside of the receding groove 106. FIG. 3 is a cross section view 300 of two floor boards 102, 104 after engaged to each other. In FIG. 3, the glue capsule 112 is broken and the glue fills the space 302 between the protruding tongue 114 and receding groove 106. The amount of glue is designed just to fill the gaps between the two floor boards, and it is not likely to have excessive glue squeezed to the surface of floor boards. If excess of glue floats to the surface, the glue can be easily wiped out. The remnant of the glue capsule 112 also stays inside the space 302. As the glue fills the entire space 302 and after the glue cures, the cured glue forms a seal and impedes water of moisture from infiltrating between the two floor boards 102, 104 and reaching the lower portion of each floor board and damaging the underlayment under the floor boards 102, 104. Those skilled in the art will appreciate that other adhesive means may be used in lieu of the glue.

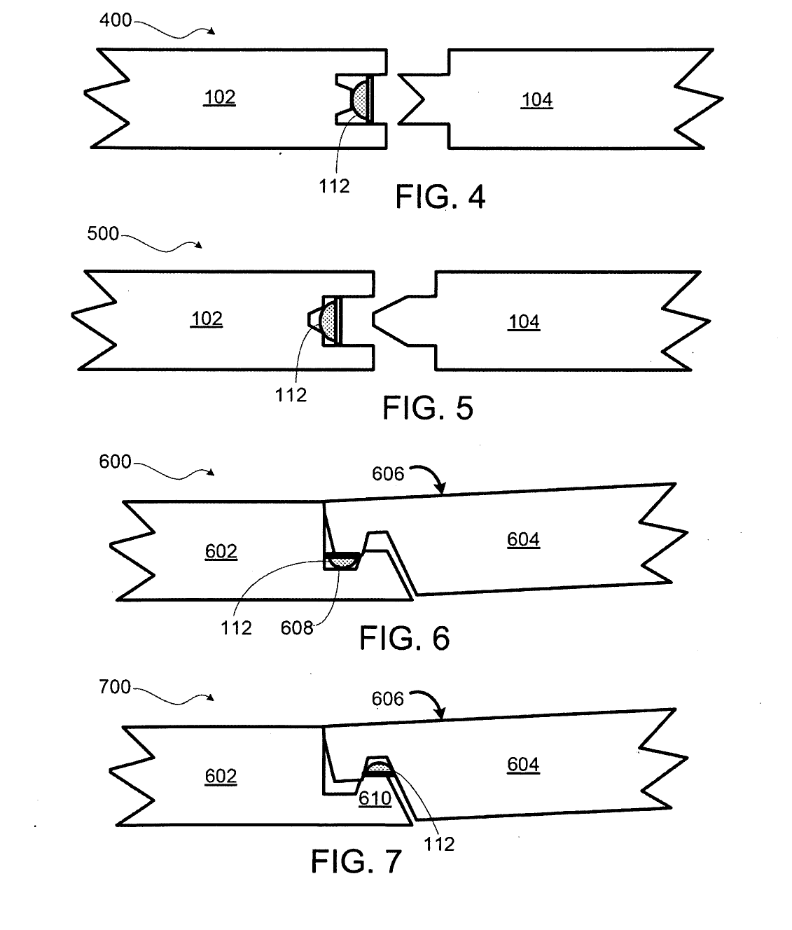

FIGS. 4 and 5 illustrate cross section views 500, 600 of floor boards with different profiles. Two floor boards 102, 104 in FIGS. 4 and 5 are engaged laterally and the glue capsules 112 are broken as two floor boards 102, 104 compressed against each other. FIGS. 6 and 7 illustrate cross section views 600, 700 of floor boards that engage each other vertically. In FIG. 6, the glue capsule 112 is placed inside an upwardly receding valley 608 of floor board 602. The capsule 112 is broken when the floor board 604 is pressed down with force 606. In FIG. 7, the glue capsule 112 is placed on the top of an upwardly protruding tongue 610 and the capsule is broken when the floor board 604 is pressed down with force 606. Those skilled in the art will appreciate floor boards with different profiles can also be easily joined together according to the principles presented in this invention.

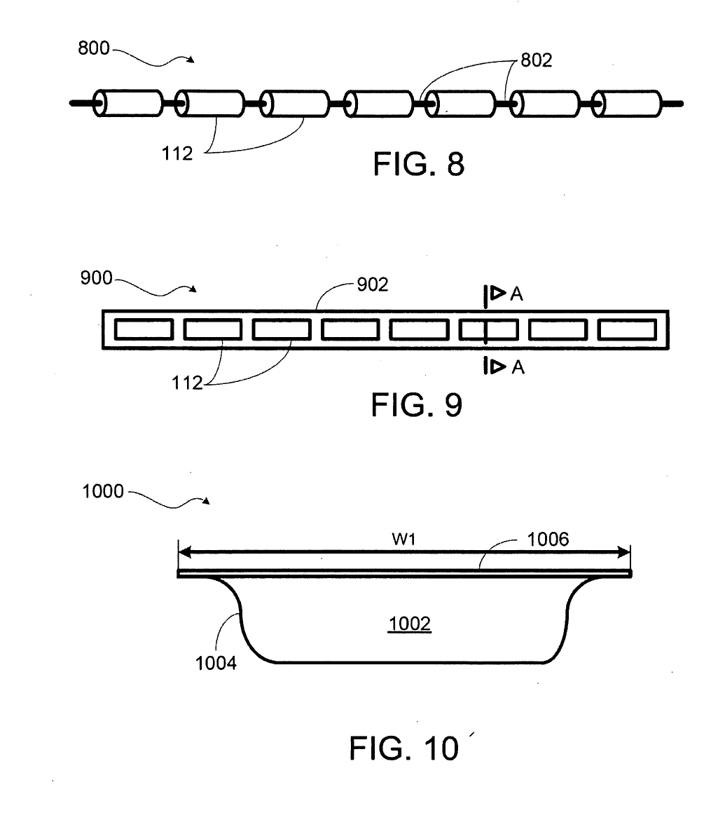

FIG. 8 is an illustration 800 of a string of glue capsules 112. The glue capsules 112 are connected to each other through a string connector 802. The string can be adjusted to any length by breaking a string connector 802. The string connector 802 may be formed by the plastic film of glue capsules 112 similar to sausages. FIG. 9 is an illustration 900 of a strip of glue capsules 112. The glue capsules 112 are part of a strip 902. The length of the strip can be adjusted by cutting anywhere between two adjacent glue capsules 112.

FIG. 10 is a cross section AA view 1000 of a glue capsule 112. A capsule 112 is formed by a thin film 1004 attached to a resilient layer 1006 and a reservoir 1002 is formed by the thin film 1004 and the resilient layer 1006. The glue is placed inside the reservoir 1002. The resilient layer 1006 has a width W1 that is slightly wider than the width of a receding groove, such that when the glue capsule 112 is placed into a receding groove, the glue capsule 112 will be “jammed” inside the receding groove. The thin film 1004 preferably has a thickness that allows the reservoir to be broken when a pressure is exerted against the glue capsule 112. Both the thin film 1004 and the resilient layer 1006 can be coated or laminated with a metal film/foil to prevent to air or moisture penetration, which may cure the glue inside of capsule 112 before installation. This coating will prolong the shelf life of the glue capsule 112. The resilient layer 1006 should be strong enough to allow the strip to be handled at a factory before placing inside a floor board. The resilient layer 1006 should also not be too thick as to prevent close fitting between two adjacent floor boards. The resilient layer 1006 is preferably flexible and slightly larger than opening of the receding groove, thus allowing the resilient layer 1006 to firmly hold the string of glue capsules inside the receding groove once the string is placed in the receding groove. The resilient layer 1006 is preferably stronger than the thin layer 1004, which gives better protection to the glue capsule from damage caused by contact outside of the receding groove. Because of resilient layer 1006 is flexible and strong and is jammed into the receding groove, the glue capsules can be easily removed from the receding groove with minor lifting force in case the glue capsules need to be replaced. Though the glue capsules 112 are shown in string or strip, one skilled in the art would appreciate that similar effect can be accomplished by placing isolated glue capsules 112 or glue tablets in strategic positions inside the floor boards.

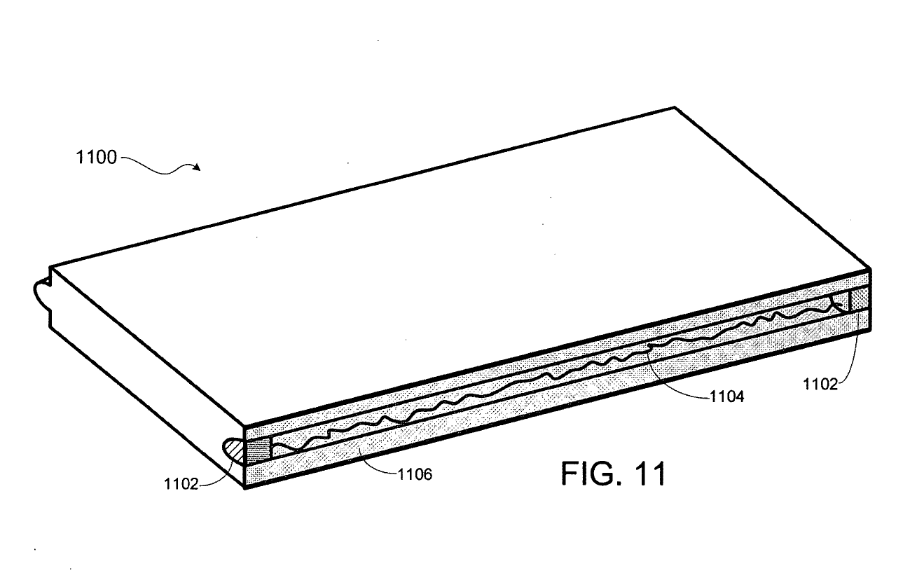

FIG. 11 illustrates a perspective view 1100 of an alternative embodiment for placing glue 1104 inside a floor board. Instead of encapsulating glue 1104 inside glue capsules, the glue 1104 can be placed directly inside the receding groove in the floor board. To prevent the glue curing before reach a construction site, two lateral seals 1102 can be placed one on each end of the receding groove and a protective film 1106 placed on the top of the receding groove thus sealing the glue 1104 inside. At the construction site, the protection film 1106 and two lateral seals are removed before engaging two adjacent floor boards. The lateral seals 1102 may be made from polystyrene or other suitable material.

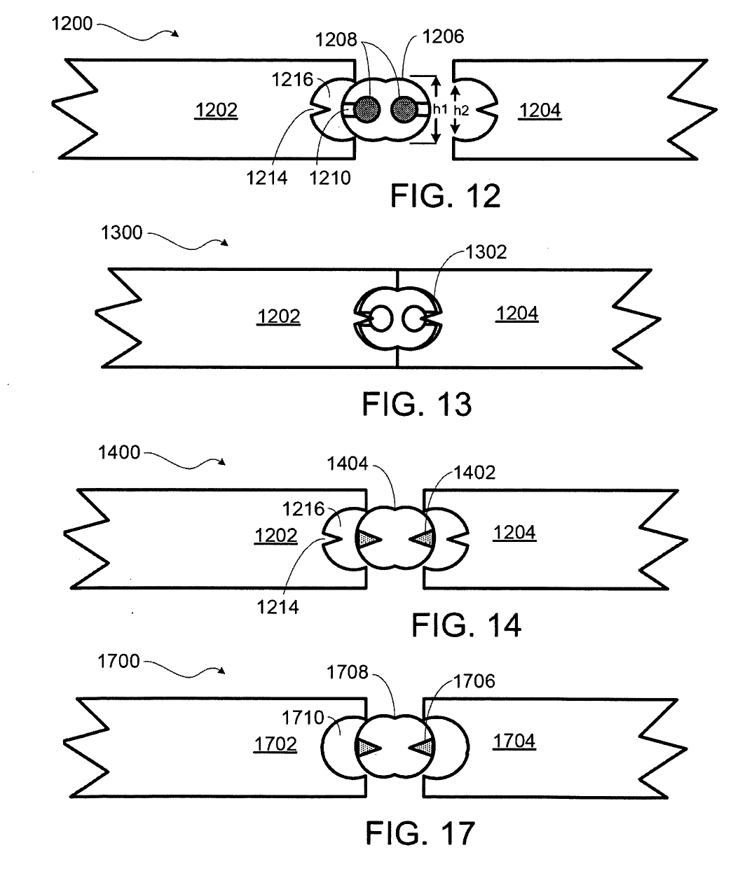

FIG. 12 illustrates another alternative embodiment 1200 for connecting two adjacent floor boards 1202, 1204 using a connector 1206. The connector 1206 can be a tube-like device extended along the length of the floor board. The connector 1206 can be made from wood, plastic, rubber or any other material with small flexibility. The connector 1206 has two portions, each portion having a chamber 1208 filled with glue. The connector 1206 has two channels 1210 opposing to each other, each channel connecting to one chamber 1208. Each floor board has a profile that includes a receding groove 1216 and a protruding tooth 1214 inside the receding groove 1216. The protruding tooth 1214 being aligned to the position of the channel 1210. Preferably the thickness h1 of the connector 1206 being slightly larger than an aperture h2 of the receding groove 1216, such that a slight pressure is needed to push the connector 1206 into the receding groove 1216. As the connector 1206 enters the receding groove 1216, the protruding tooth 1214 penetrates the channel 1210 and punctures a film that seals the glue inside the chamber 1208. FIG. 13 illustrates a cross section view 1300 of two floor boards 1202, 1204 of FIG. 12 engaged to each other. One portion of the connector 1206 is inserted into one floor board 1202, and other portion of the connector 1206 is inserted into the other floor board 1204. The glue leaks from the chamber 1208 and fills the space 1302 between the connector 1206 and the floor board. Two adjacent floor boards cannot be easily separated from each other because of glue and also because of the connector 1206 share by two floor boards. FIG. 18 depicts an alternative embodiment 1800 in which the connector 1802 is part of one floor board 1204 and there is only one glue chamber 1804. This embodiment 1800 makes installation easier since there is fewer parts to handle.

FIG. 14 illustrates an alternative embodiment 1400 of a connector 1404 of different construction. The connector 1404 has two chambers 1402 placed on the opposite sides. The glue is placed inside the chambers 1402 and sealed with a protective film. As the connector 1404 is pushed inside the receding groove 1216 of the floor board 1202, the protective film is punctured by the protruding tooth 1214 and the glues leaks out. Those skilled in the art will appreciate other shapes of connectors may also be implemented without departing from the spirit of this invention. FIG. 17 illustrates an alternative embodiment 1700, where there is no protruding tooth inside the receding groove 1710. The connector 1708 has two chambers 1706 placed on the opposite sides with glue filled inside each chamber 1706 and each chamber 1706 being sealed by a protective film. As the connector 1708 is pushed inside the floor boards 1702 and 1704, the squeezing force exerted on the connector 1708 breaks the protective film and thus allowing the glue to leak out and fill the receding groove 1710.

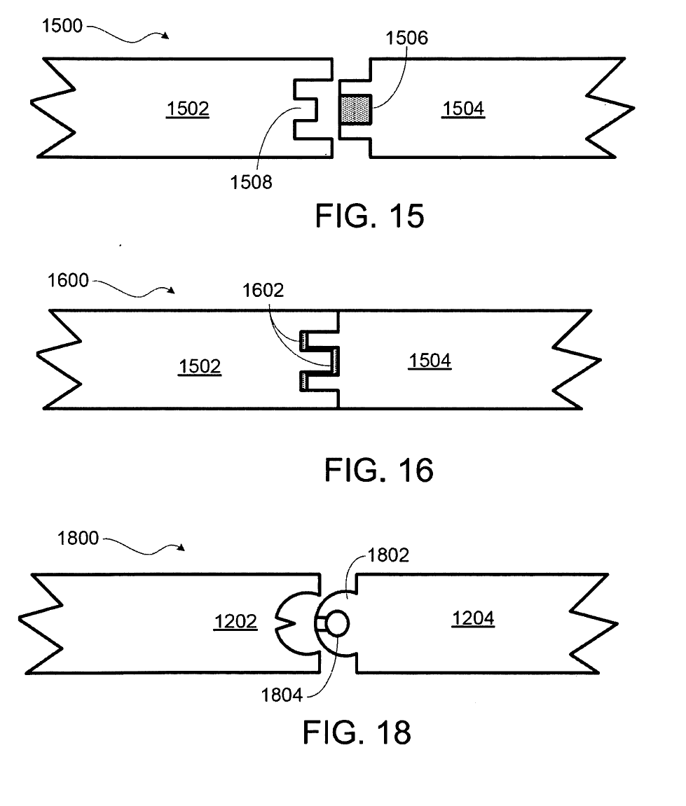

FIG. 15 is an illustration 1500 of two floor boards 1502, 1504 that engage through double locks. The floor board 1504 has a compartment 1506 filled with the glue and sealed with plastic film or metal foil. The compartment 1506 can be pre-coated, so the glue will not cure within the compartment 1506. The compartment 1506 is punctured by a protruding tongue 1508 when two floor boards 1502, 1504 are pushed against each other. FIG. 16 is an illustration 1600 of two floor boards 1502, 1504 of FIG. 15 engaged to each other. The glue fills the space 1602 between two floor boards and bonding all the areas except the coated area within compartment 1506.

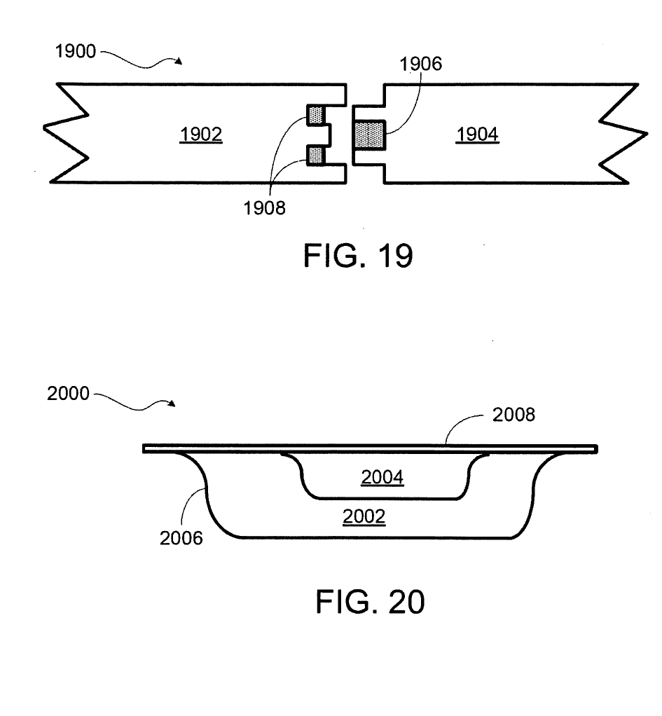

The present invention may also use two different glue components instead of one single glue. The two different glue components can be encapsulated in two separate capsules in the string, or using double strings, one string for each glue component, within installed in separated the receding grooves on opposite floor boards. When the two components are mixed as two adjacent floor boards are engaged, they would cure and form a strong bonding. Normally, for two components the capsule will be made much smaller; in some case, installers may need to slide floor boards during the installation, and the sliding of the floor boards will help the mixing of the two glue components. FIG. 19 is an illustration 1900 of two adjacent floor boards 1902, 1904, each floor having a different glue component. Floor board 1902 has a first glue component 1908 installed in two receiving grooves and floor board 1904 has a second glue component 1906 installed in its receiving groove. When the two floor boards engage, two different glue components will be mixed and filling the space between two floor boards in a way that is similar to what FIG. 16 illustrates.

In an alternative embodiment, two glues may be placed sequentially in a string of glue capsules illustrates in FIG. 8. A capsule with glue A may be followed by a capsule of glue B, so on so forth; so the string of glue capsules will be with glue ABABA. In yet another alternative embodiment for two glue components shown in FIG. 20. A first glue component is stored in reservoir 2004, which is immersed in reservoir 2002 where the second glue component is stored. The glue capsule 2000 has a thin outer layer 2006 and a resilient top layer 1008. When the glue capsule 2000 is placed in a receding groove and then broken by a compression force from the protruding tongue, two reservoirs 2002, 2004 will both break and thus mixing two glue components.

The present invention enables easy installation of floor boards. An installer places a first floor board with a receding groove on a surface. The receding groove has either a string of glue capsules or adhesive sealed by lateral sealers and a protective film. If the receding groove has adhesive, then the installer needs to remove the protective film and lateral sealers before placing the first floor board on the surface. After the first floor board is placed on the surface, the installer can place a second floor board with a protruding tongue adjacent to the first floor board. By forcing the protruding tongue inside the receding groove, the protruding tongue presses against the glue capsules and breaking them. As the glue capsules are broken, the glue leaks out into the receding groove and distributes around the surface of the protruding tongue and receding groove, and thus attaching the first floor board with the second floor board.

The above installation method prevents the installer from direct contact with the glue, thus avoiding messy handling, hazardous contact, and surface contamination during the installation process. This preinstalled glue starts its curing process right after the installation, and the curing time window is automatically set with the installation. Further, by applying the right amount of glue at the right location makes this glue-based installation process easy and simple.

Though the description of this application is centered around floor boards, the technology disclosed can be also used for other applications such as furniture, cabinets, wall panel, ceiling, roof and housing construction, and structures where glue can be used or preinstalled glue is desired. The technology disclosed herein can also be used with floor boards of other non-wood material such as plastic, foam, metal, cement, glass, rubber, bamboo, paper, melamine, fiberboards and their composites, etc. The terms and expressions that have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents. Dimensions in the drawings here presented are not to the scale unless otherwise indicated.

What is claimed is:

1. A floor board having a length, comprising:
a protruding tongue;
a receding groove; and
an adhesive placed inside the receding groove.

2. The floor board of claim 1, wherein the protruding tongue and the receding groove extend along the length.

3. The floor board of claim 1, wherein the protruding tongue and the receding groove being located at two ends opposite from each other.

4. The floor board of claim 1 wherein the floor board being made from wooden material.

5. The floor board of claim 1, wherein the adhesive being a string of glue capsules.

6. The floor board of claim 1, wherein the receding groove having two ends, further comprising two lateral seals, one on each end of the receding groove, and one protective film placed on the top of the receding groove.

7. A floor board having a length, comprising:
an upwardly receding valley;
an upwardly protruding tongue adjacent to the upwardly receding valley; and
an adhesive placed inside the upwardly receding valley.

8. The floor board of claim 7, wherein the protruding tongue and the receding groove extend along the length.

9. The floor board of claim 7, wherein the protruding tongue and the receding groove being located at one end of the floor board.

10. The floor board of claim 7, wherein the floor board being made from wooden material.

11. The floor board of claim 7, wherein the adhesive being a string of glue capsules

12. A floor system comprising:
a first floor board having a first end, wherein the first end having a first receding groove and the first receding groove having a first aperture;
a second floor board having a second end, wherein the second end having a second receding groove and the second receding groove having a second aperture; and
a connector having a first portion, a second portion, a first chamber located in the first portion and a second chamber located in the second portion, the connector having a thickness, and the first chamber and the second chamber being filled with glue, the thickness of the connector being larger than the first aperture and the second aperture,
wherein, after the first portion of the connector being inserted into the first receding groove and the second portion of the connector being inserted into the second receding groove, the glue from the first chamber leaks into the first receding groove and the glue from the second chamber leaks into the second receding groove.

13. The floor system of claim 13, further comprising a first protruding tooth inside the first receding groove and a second protruding tooth inside the second receding groove.

14. The floor system of claim 13, further comprising a first channel connected to the first chamber and a second channel connected to the second chamber.

15. The floor system of claim 13, wherein the first floor board and the second floor board being made from wood.

16. The floor system of claim 13, wherein the connector being made from rubber.

17. A method for installing floor boards on a surface, comprising the steps of:
placing a first floor board with a receding groove on the surface, the receding groove having adhesive;
placing a second floor board with a protruding tongue adjacent to the first floor board;
pressing the protruding tongue of the second floor board against the receding groove of the first floor board;
inserting the protruding tongue of the second floor board into the receding groove of the first floor board;
distributing the adhesive inside the receding groove; and
attaching the protruding tongue to the receding groove.

18. The method of claim 17, further comprising the step of removing lateral seals and a protective film from the receding groove.

19. The method of claim 17, further comprising the step of sliding the first floor board parallelly against the second floor board.

20. An adhesive capsule for use inside a receding groove with a first width, comprising:
a first reservoir made from a thin film for storing a first adhesive; and
a resilient layer covering the reservoir, the resilient layer having a second width,
wherein the second width being wider than the first width.

21. The adhesive capsule of claim 20, wherein the resilient layer is made from a material that is stronger than the material for the first reservoir.

22. The adhesive capsule of claim 20, wherein the resilient layer is coated with a metal film.

23. The adhesive capsule of claim 20, wherein the resilient layer is laminated.

24. The Adhesive capsule of claim 20, further comprising a second reservoir inside the first reservoir, the second reservoir having a second adhesive.
